(19) United States
(12) Patent Application Publication
(10) Pub. No.: US 2021/0324860 A1
(43) Pub. Date: Oct. 21, 2021

(54) COMPRESSOR AND CHILLER SYSTEM HAVING THE SAME

(71) Applicant: LG ELECTRONICS INC., Seoul (KR)

(72) Inventors: Uisik HWANG, Seoul (KR); Jinhee Jeong, Seoul (KR); Hyunwook Han, Seoul (KR); Jungho Kang, Seoul (KR); Heewoong Lee, Seoul (KR); Cheolmin Kim, Seoul (KR)

(21) Appl. No.: 17/230,052

(22) Filed: Apr. 14, 2021

(30) Foreign Application Priority Data
Apr. 21, 2020 (KR) 10-2020-0048120

(51) Int. Cl. F04D 1/06; F25B 31/02; F04D 13/02; F04D 29/043; F04D 29/22; F04D 29/44; F04D 29/041; F04D 29/048

(52) U.S. Cl. CPC F04D 1/06; F25B 31/026; F04D 13/02; F04D 29/048; F04D 29/22; F04D 29/445; F04D 29/0413; F04D 29/043

(57) ABSTRACT

The present disclosure relates to a compressor including: a first impeller suctioning a refrigerant in an axial direction and compressing the refrigerant in a direction forming an acute angle with the axial direction; a second impeller suctioning the refrigerant, compressed by the first impeller, in the axial direction and compressing the refrigerant in a centrifugal direction; a motor rotating the first impeller and the second impeller; and a rotating shaft coupled with the first impeller, the second impeller, and the motor, wherein the first impeller is coupled to one end in the axial direction of the rotating shaft, and the second impeller is coupled to the other end in the axial direction of the rotating shaft; and the first impeller and the second impeller suction the refrigerant in a same direction.

### BACKGROUND OF THE INVENTION

### 1. Field of the Invention

The present disclosure relates to a compressor and a chiller system.

### 2. Description of the Related Art

Generally, a chiller system supplies chilled water to demand sources of the chilled water, and provides cooling by heat exchange between a refrigerant, circulating through a refrigeration system, and chilled water circulating between the demand sources and the refrigeration system. As large-capacity cooling equipment, the chiller systems may be installed in large buildings and the like.

In an existing chiller system, a compressor compresses the refrigerant in two stages by using a two-stage centrifugal impeller. A two-stage compressor has an effect in that the compressor may compress the refrigerant to a high-pressure with excellent efficiency.

However, when two centrifugal impellers are used, there is a problem in that the size of the impellers increases since there is a limit to an increase in RPM. The centrifugal impeller suctions the refrigerant in an axial direction and discharges the refrigerant in a centrifugal direction (radial direction intersecting the axial direction). In this case, there are problems in that: it is required to provide a connection passage, which connects a first-stage impeller and a second-stage impeller, on the outside of a casing of the compressor; a loss may occur in the connection passage; and a size of the compressor may increase as the connection pipe is further included.

### SUMMARY OF THE INVENTION

In order to solve the above problems, it is an object of the present disclosure to provide a compressor, in which by using a mixed flow impeller, the specific speed may increase such that a size of the impeller may be reduced compared to a case where a centrifugal impeller is used.

It is another object of the present disclosure to provide a compressor, in which by using a mixed flow impeller and by configuring the compressor with a highly efficient arrangement, the compressor may be reduced in size.

It is yet another object of the present disclosure to provide a compressor with improved compression performance.

The objects of the present disclosure are not limited to the aforementioned objects and other objects not described herein will be clearly understood by those skilled in the art from the following description.

In order to achieve the above objects, there is provided a compressor according to an embodiment of the present disclosure, in which a mixed flow impeller is used as a first-stage impeller.

Further, a thrust bearing is disposed in a dead zone of a diffuser used in the mixed flow impeller.

Specifically, in accordance with an aspect of the present disclosure, the above and other objects can be accomplished by providing a compressor, including: a first impeller suctioning a refrigerant in an axial direction and compressing the refrigerant in a direction forming an acute angle with the axial direction; a second impeller suctioning the refrigerant, compressed by the first impeller, in the axial direction and compressing the refrigerant in a centrifugal direction; a motor rotating the first impeller and the second impeller; and a rotating shaft coupled with the first impeller, the second impeller, and the motor, wherein the first impeller is coupled to one end in the axial direction of the rotating shaft, and the second impeller is coupled to the other end in the axial direction of the rotating shaft; and the first impeller and the second impeller suction the refrigerant in a same direction.

The first impeller may include a mixed flow impeller, and the second impeller may include a centrifugal impeller.

The motor may be disposed between the first impeller and the second impeller.

In addition, the compressor may further include a diffuser diffusing the refrigerant compressed by the first impeller, wherein an inlet of the diffuser may be disposed closer to the first impeller in a radial direction of the rotating shaft than an outlet of the diffuser: and the outlet of the diffuser may be disposed closer to the second impeller in the axial direction than the inlet of the diffuser.

A direction of the inlet of the diffuser may be between a first axial direction, in which the refrigerant is suctioned, and the radial direction of the rotating shaft; and a direction of the outlet of the diffuser may be parallel to the first axial direction.

The diffuser may be defined as a cavity formed in casings which accommodate the first impeller, the second impeller, the motor, and the rotating shaft.

The diffuser may have an annular shape surrounding the rotating shaft.

Moreover, the compressor may further include a thrust bearing supporting the rotating shaft in the axial direction, wherein the thrust bearing may be disposed to overlap the diffuser in the radial direction.

The thrust bearing may be disposed closer to the rotating shaft than the diffuser.

The compressor may further include a diffusing passage connected to the outlet of the diffuser and guiding the diffused refrigerant to the second impeller, wherein the diffusing passage may be disposed to overlap the motor in the radial direction.

The motor may be disposed closer to the rotating shaft than the diffusing passage.

The diffusing passage may be defined as a cavity formed in casings which accommodate the first impeller, the second impeller, the motor, and the rotating shaft.

In addition, the compressor may further include a plurality of magnetic bearings supporting the rotating shaft in a radial direction intersecting the axial direction of the rotating shaft.

As least some of the magnetic bearings may be disposed to overlap the diffuser in the radial direction.

Among the magnetic bearings, a magnetic bearing, disposed adjacent to the thrust bearing, may be disposed closer to the motor in the axial direction than the thrust bearing.

In accordance with another aspect of the present disclosure, the above and other objects can be accomplished by providing a compressor, including: a first impeller suctioning a refrigerant in an axial direction and compressing the refrigerant in a direction forming an acute angle with the axial direction; a second impeller suctioning the refrigerant, compressed by the first impeller, in the axial direction and compressing the refrigerant in a centrifugal direction; a motor rotating the first impeller and the second impeller; a rotating shaft coupled with the first impeller, the second impeller, and the motor; a thrust bearing supporting the rotating shaft in the axial direction; and a diffuser diffusing the refrigerant compressed by the first impeller, wherein the thrust bearing may be disposed in a receiving space between the diffuser and the rotating shaft.

Other detailed matters of the exemplary embodiments are included in the detailed description and the drawings.

### BRIEF DESCRIPTION OF THE DRAWINGS

FIG. 1 is a diagram illustrating a chiller system according to an embodiment of the present disclosure.

FIG. 2 is a block diagram illustrating a relationship among components connected to a controller.

FIG. 3 is a cross-sectional view of a compressor according to an embodiment of the present disclosure.

FIG. 4 is an enlarged cross-sectional view of a portion of FIG. 3.

FIG. 5 is a diagram illustrating a flow of a refrigerant in a compressor according to an embodiment of the present disclosure.

### DETAILED DESCRIPTION OF THE PREFERRED EMBODIMENTS

Advantages and features of the present invention and methods for achieving those of the present invention will become apparent upon referring to embodiments described later in detail with reference to the attached drawings. However, embodiments are not limited to the embodiments disclosed hereinafter and may be embodied in different ways. The embodiments are provided for perfection of disclosure and for informing persons skilled in this field of art of the scope of the present invention. The same reference numerals may refer to the same elements throughout the specification.

Spatially-relative terms such as “below”, “beneath”, “lower”, “above”, or “upper” may be used herein to describe one element's relationship to another element as illustrated in the Figures. It will be understood that spatially-relative terms are intended to encompass different orientations of the device in addition to the orientation depicted in the Figures. For example, if the device in one of the figures is turned over, elements described as “below” or “beneath” other elements would then be oriented “above” the other elements. The exemplary terms “below” or “beneath” can, therefore, encompass both an orientation of above and below. Since the device may be oriented in another direction, the spatially-relative terms may be interpreted in accordance with the orientation of the device.

The terminology used in the present disclosure is for the purpose of describing particular embodiments only and is not intended to limit the disclosure. As used in the disclosure and the appended claims, the singular forms “a”, “an” and “the” are intended to include the plural forms as well, unless context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, the thickness or size of each layer is exaggerated, omitted, or schematically illustrated for convenience of description and clarity. Also, the size or area of each constituent element does not entirely reflect the actual size thereof.

Hereinafter, exemplary embodiments of the present invention will be described with reference to the accompanying drawings.

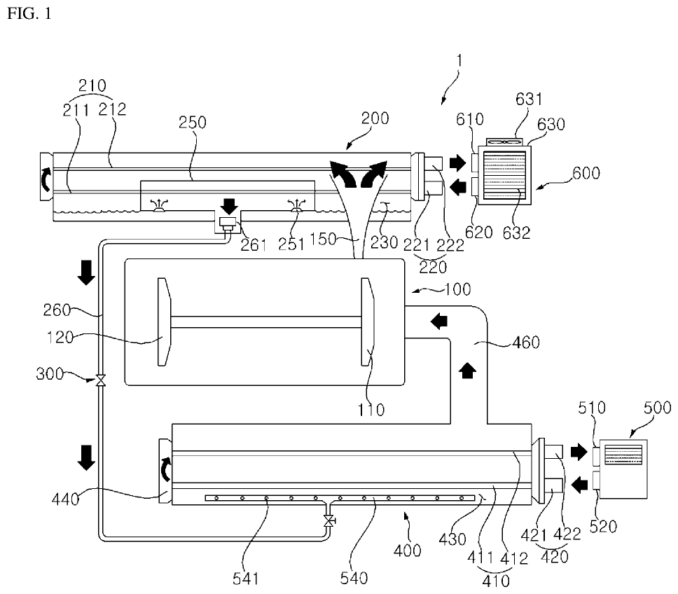

FIG. 1 is a diagram illustrating a chiller system including a compressor 100 of the present disclosure. The compressor 100 according to an embodiment of the present disclosure may not only function as part of the chiller system, but may also be included in an air conditioner, and may be included in any device as long as the device may compress a gaseous material.

Referring to FIG. 1, the chiller system 1 according to an embodiment of the present disclosure includes: a compressor 100 configured to compress a refrigerant; a condenser 200 configured to condense the refrigerant by heat exchange between the refrigerant, compressed by the compressor 100, and a coolant; an expander 300 configured to expand the refrigerant condensed by the condenser 200; an evaporator 400 configured to cool cold water while evaporating the refrigerant by heat exchange between the refrigerant, expanded by the expander 300, and the cold water.

In addition, the chiller system 1 according to an embodiment of the present disclosure may further include: a coolant unit 600 configured to heat the coolant by heat exchange between the refrigerant, compressed by the condenser 200, and the coolant; and an air conditioning unit 500 configured to cool the cold water by heat exchange at the evaporator 400 between the expanded refrigerant and the cold water.

The condenser 200 provides a space for heat exchange between a high-pressure refrigerant, compressed by the compressor 100, and the coolant introduced from the coolant unit 600. The compressed high-pressure refrigerant may be condensed by heat exchange with the coolant.

The condenser 200 may include a shell-tube type heat exchanger. Specifically, the high-pressure refrigerant, compressed by the compressor 100, may be introduced into a condensing space 230, corresponding to an internal space of the condenser 200, through a condenser connection passage 160. Further, a coolant passage 210, through which the coolant introduced from the coolant unit 600 may flow, is formed in the condensing space 230.

The coolant passage 210 may include a coolant inlet passage 211, into which the coolant is introduced from the coolant unit 600, and a coolant discharge passage 212, through which the coolant is discharged to the coolant unit 600. The coolant introduced into the coolant inlet passage 211 may be heat-exchanged with the refrigerant inside the condensing space 230, and then may pass through a coolant connection passage 240, formed at one end inside the condenser 200 or formed outside thereof, to be introduced into the coolant discharge passage 212.

The coolant unit 600 and the condenser 200 may be connected to each other through a coolant tube 220. The coolant tube 220 may serve as a flow path of the coolant between the coolant unit 600 and the condenser 200, and may be made of a rubber material and the like so as to prevent the coolant from leaking to the outside.

The coolant tube 220 includes a coolant inlet tube 221 connected to the coolant inlet passage 211, and a coolant discharge tube 222 connected to the coolant discharge passage 212. As for the overall coolant flow, the coolant is heat-exchanged with air or a liquid at the coolant unit 600, and then is introduced into the condenser 200 through the coolant inlet tube 221. The coolant introduced into the condenser 200 sequentially passes through the coolant inlet passage 211, the coolant connection passage 240, and the coolant discharge passage 212 which are provided in the condenser 200, so as to be heat-exchanged with the refrigerant introduced into the condenser 200, and then passes through the coolant discharge tube 222 again to flow into the coolant unit 600.

In addition, the coolant unit 600 may perform air cooling of the coolant after the coolant absorbs heat from the refrigerant by heat exchange at the condenser 200. The coolant unit 600 includes a main body 630, a coolant inlet pipe 610 serving as an inlet through which the coolant after having absorbed heat is introduced from the coolant discharge tube 222, and a coolant discharge pipe 620 serving as an outlet through which the coolant after being cooled in the coolant unit 600 is discharged.

By using air, the coolant unit 600 may cool the coolant introduced into the main body 630. Specifically, the main body 630 has a fan generating an air flow, an air outlet 631 through which air is discharged, and an air inlet 632 through which air flows into the main body 630.

Air discharged through the air outlet 631 after being heat-exchanged may be used for heating. The refrigerant, condensed after being heat-exchanged at the condenser 200, stagnates in a lower portion of the condensing space 230. The stagnant refrigerant is fed into a refrigerant box 250, provided inside the condensing space 230, to flow into the expander 300.

The refrigerant box 250 may be introduced through a refrigerant inlet 251, and the introduced refrigerant may be discharged through an evaporator connection passage 260. The evaporator connection passage 260 has an evaporator connection passage inlet 261 which may be disposed below the refrigerant box 250.

The evaporator 400 may include an evaporation space 430 in which heat-exchange takes place between the refrigerant, expanded by the expander 300, and the cold water. In the evaporator connection passage 260, the refrigerant having passed through the expander 300 flows to a refrigerant spray device 450 provided in the evaporator 400 and passes through refrigerant injection holes 451 of the refrigerant spray device 450 to be diffused evenly in the evaporator 400.

Further, in the evaporator 400, a cold water passage 410 is provided which includes: a cold water inlet passage 411, through which cold water flows into the evaporator 400; and a cold water discharge passage 412, through which the cold water is discharged outside of the evaporator 400.

The cold water may be introduced or discharged through a cold water tube 420 communicating with the air conditioning unit 500 provided outside of the evaporator 400. The cold water tube 420 includes a cold water inlet tube 421, serving as a passage through which cold water inside the air conditioning unit 500 flows toward the evaporator 400, and a cold water discharge tube 422 serving as a passage through which cold water after being heat-exchanged at the evaporator 400 flows toward the air conditioning unit 500. That is, the cold water inlet tube 421 communicates with the cold water inlet passage 411, and the cold water discharge tube 422 communicates with the cold water discharge passage 412.

As for the flow of cold water, after passing through the air conditioning unit 500, the cold water inlet tube 421, and the cold water inlet passage 411, the cold water passes through a cold water connection passage 440 provided at one end inside the evaporator 400 or provided outside thereof, and then flows into the air conditioning unit 500 again through the cold water discharge passage 412 and the cold water discharge tube 422.

The air conditioning unit 500 cools the cold water by using the refrigerant. The cooled cold water may cool the indoor air by absorbing heat from the air in the air conditioning unit 500. The air conditioning unit 500 may include a cold water discharge pipe 520 communicating with the cold water inlet tube 421, and a cold water inlet pipe 510 communicating with the cold water discharge tube 422. After being heat-exchanged at the evaporator 400, the refrigerant may flow into the compressor 100 again through a compressor connection passage 460.

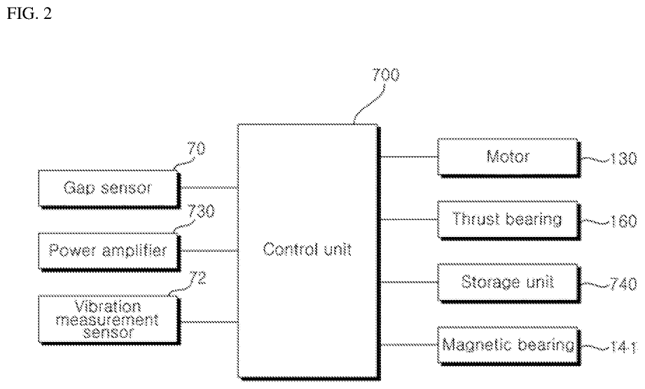

Referring to FIG. 2, in the present disclosure, a controller 700 may be further included which performs a surge avoidance operation based on a vibration frequency measured by the vibration measuring sensor 72.

The controller 700 may control a power amplifier 730 amplifying the magnitude of current applied to the vibration measuring sensor 72, a magnetic bearing 141, a motor 130, and a thrust bearing 160.

By controlling the power amplifier 730, the controller 700 may adjust the magnitude of current applied to the magnetic bearing 141, the motor 130, and the thrust bearing 160; and by using the vibration measuring sensor 72, the controller 700 may detect a change in position of a rotating shaft according to a change in current.

Values measured by the vibration measuring sensor 72 are stored in a storage unit 740. Data, such as a reference position, a normal position range, an eccentric position, and the like, may be pre-stored in the storage unit 740. The data may be used for a later determination on conditions of surge occurrence, in which by comparing the values stored in the storage unit 740 with the measured values, the controller 700 may determine whether to perform a surge avoidance operation.

Specifically, upon determining that the vibration frequency falls outside a normal vibration frequency range, the controller 700 may perform the surge avoidance operation.

Most of the surge events in the compressor 100 occur due to rotating stall caused by the growth of flow separation. The magnetic bearing controls the position of the shaft, such that the magnetic bearing may vibrate a shaft for a very short period of time which is short enough not to affect the system, and if an inverter product may manage the flow separation before surge takes place by controlling an RPM of the compressor 100, an operation may be performed while avoiding the surge.

The flow separation grows in a direction to close a refrigerant flow passage, such that by analyzing a vibration component of the discharge passage 150, it is possible to detect the growth of flow separation based on a change in a Blade Passing Frequency (BPF) value. The present disclosure provides a method of avoiding surge by observing and controlling the growth of flow separation and removing the flow separation. The BPF may be defined as a value obtained by multiplying the number of blades by a current operating frequency of the motor 130.

Here, a normal vibration frequency may be an experimentally determined value. In another example, if the vibration frequency of the discharge passage 150 is less than a BPF value, the controller 700 may determine that the vibration frequency falls outside the normal vibration frequency range. In yet another example, if a vibration frequency of the discharge passage 150, which is less than the BPF value, is maintained for a predetermined period of time, the controller 700 may determine that the vibration frequency falls outside the normal vibration frequency range.

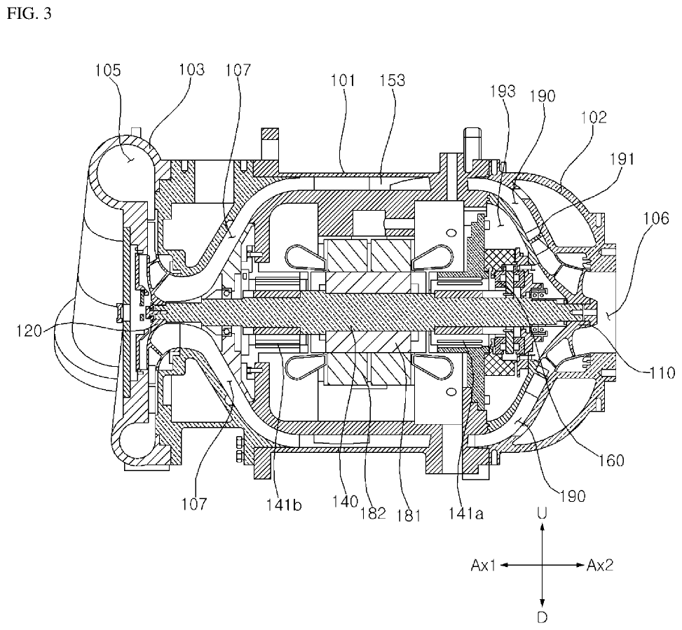

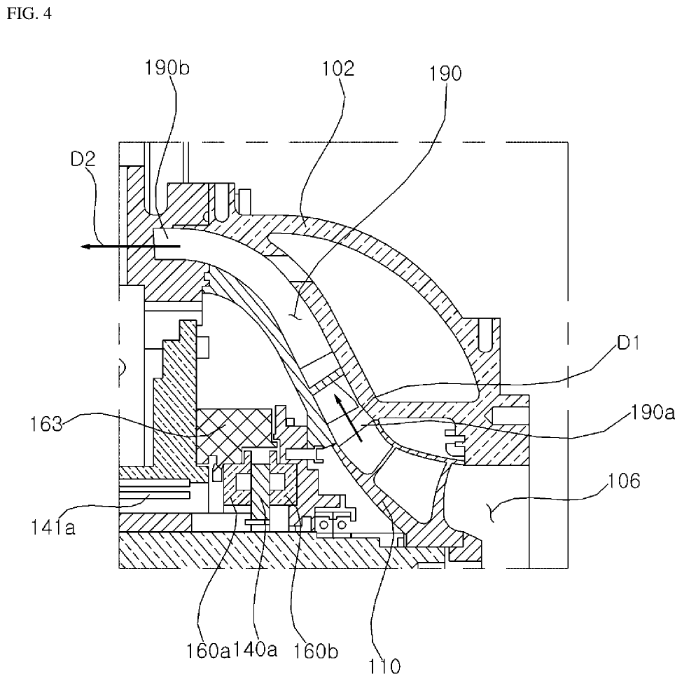

The compressor 100 will be described below with reference to FIGS. 3 and 4.

The compressor 100 according to an embodiment of the present disclosure is provided as a two-stage compressor 100. However, this is merely an example, and the compressor 100 according to the present disclosure is not limited thereto. The compressor 100 includes a first impeller 110, a second impeller 120, a motor 180, and a rotating shaft 140. In addition, the compressor 100 may further include casings 101, 102, and 103 accommodating the first impeller 110, the second impeller 120, the motor 180, and the rotating shaft 140.

The compressor 100 may include a shell 101 and shell covers 102 and 103 coupled to the shell 101. In a broad sense, the shell covers 102 and 103 may be understood as part of the shell 101. The shell 101 and the shell covers 102 and 103 may be collectively referred to as the casings 101, 102, and 103.

Specifically, the shell 101 has an approximately cylindrical shape, and both sides thereof are open. The shell covers 102 and 103 may be respectively coupled to both open sides of the shell 101.

The shell covers 102 and 103 may include a first shell cover 102 coupled to one open side of the shell 101, and a second shell cover 103 coupled to the other open side of the shell 101. The internal space of the shell 101 may be air-tightly sealed by the shell covers 102 and 103.

Based on FIGS. 2 and 3, the first shell cover 102 may be disposed on the right side of the compressor 100, and the second shell cover 103 may be disposed on the left side of the compressor 100. In other words, the first and second shell covers 102 and 103 may be disposed to face each other.

Here, the left side may be referred to as a first axial direction Ax1 which is parallel to the axial direction, the right side may be referred to as a second axial direction Ax2 which is opposite to the first axial direction Ax1 parallel to the axial direction. Further, based on FIG. 3, a vertical direction may be referred to as a radial direction perpendicular to the axial direction.

A first suction pipe (not shown), through which the refrigerant is suctioned, is connected to the first shell cover 102; and a discharge pipe 105, through which the compressed refrigerant is discharged, is connected to the second shell cover 103. While the first suction pipe is omitted from FIG. 3, a first suction unit 106, to which the first suction pipe is connected, is illustrated herein.

A second suction unit 107, to which the refrigerant discharged from the first shell cover 102 is introduced, is formed at the second shell cover 103.

In this case, the refrigerant flowing from the evaporator 40 is introduced into the first suction unit 106. The first suction unit 106 may be connected to the compressor connection

The refrigerant introduced into the first shell cover 102 through the first suction unit 106 may flow to the second suction unit 107. The refrigerant, discharged from the first shell cover 102, may flow to the second suction unit 107. The refrigerant, flowing to the second shell cover 103 through the second suction unit 107 may be discharged through the discharge pipe 105. Further, the discharge pipe 105 may be connected to the condenser 20. The discharge pipe 105 may be connected to a condenser connection passage 150.

In addition, a control box (not shown) may be provided at the first and second shell covers 102 and 103. One side of the control box may protrude to allow a user to control each component. The control box may be provided at each of the first and second shell covers 102 and 103.

Further, the first and second impellers 110 and 120 are provided at the first and second shell covers 102 and 103, respectively, to compress the refrigerant.

The first impeller 110 suctions the refrigerant in the axial direction and compresses the refrigerant in a direction forming an acute angle with the axial direction. More specifically, the first impeller 110 suctions the refrigerant in the first axial direction Ax1 and discharges the refrigerant in a direction between the first axial direction Ax1 and the radial direction.

For example, the first impeller 110 may include a mixed flow impeller. By using the mixed flow impeller, a specific speed of the compressor 100 may increase, and a size of the impeller may be reduced.

The first impeller 110 may be coupled to one end in the axial direction of the rotating shaft 140. Specifically, the first impeller 110 may be coupled to a right end of the rotating shaft 140. As the first impeller 110 suctions the refrigerant in a direction from left to right, the first impeller 110 may have a radius which increases from right to left.

The second impeller 120 suctions the refrigerant in the axial direction and compresses the refrigerant in a centrifugal direction. More specifically, the second impeller 120 suctions the refrigerant in the first axial direction Ax1 and discharges the refrigerant in a direction intersecting (preferably perpendicular to) the first axial direction Ax1.

For example, the second impeller 120 may include a centrifugal impeller. The second impeller 120 may be coupled to the other end in the axial direction of the rotating shaft 140. Specifically, the second impeller 120 may be coupled to a left end of the rotating shaft 140. As the second impeller 120 suctions the refrigerant in a direction from right to left, the second impeller 120 may have a radius which increases from right to left. The first impeller 110 and the second impeller 120 suction the refrigerant in the same direction.

Specifically, the first and second impellers 110 and 120 compress and discharge the refrigerant introduced in the axial direction through the first and second inlets 106 and 107. The refrigerant is primarily compressed by the first impeller 110, and the refrigerant compressed by the first impeller 110 is then compressed by the second impeller 120.

The refrigerant compressed by the first impeller 110 is supplied to the second impeller 120 through a passage. The aforementioned passage may be defined as a cavity formed in the casings 101, 102, and 103 of the compressor 100. As the passage is formed as the cavity formed in the casings 101, 102, and 103, a separate connection pipe formed outside of the compressor 100 may be omitted, such that a volume of the compressor 100 may be reduced.

In the present disclosure, a diffuser 190 may be installed to diffuse the refrigerant discharged by the first impeller 110. The diffuser 190, disposed at a position adjacent to the impeller 300, may convert dynamic pressure into static pressure by diffusing a working fluid compressed to a high pressure by the first impeller 110.

An outlet end of the first impeller 110 and the second inlet 107 of the second impeller 120 may be connected to the diffuser 190. It is also possible that the diffuser 190 may be connected to the outlet end of the first impeller 110 and a diffusing passage 153, and the diffusing passage 153 may be connected to the second inlet 107.

As one end of the diffuser 190 is connected to the outlet end of the first impeller 110, and the other end thereof is connected to the diffusing passage 153, the diffuser 190 may diffuse the refrigerant discharged by the first impeller 110. The diffuser 190 may change a direction of the refrigerant discharged by the first impeller 110. As the diffuser 190 changes the direction of the discharged refrigerant, the refrigerant discharged by the first impeller 110 may flow in the axial direction along the passage formed in the casings 101, 102, and 103 of the compressor 100, such that there is no need for a separate connection pipe on the outside of the compressor 100.

Specifically, an inlet 190a of the diffuser 190 is positioned closer to the first impeller 110 that an outlet 190b of the diffuser 190 in the radial direction of the rotating shaft 140, and the outlet 190b of the diffuser 190 is positioned closer to the second impeller 120 than the inlet 190a of the diffuser 190 in the axial direction.

In addition, a direction D1 of the inlet of the diffuser 190 may be between the first axial direction Ax1, in which the refrigerant is suctioned, and the radial direction of the rotating shaft 140, and a direction D2 of the outlet 190b of the diffuser 190 may be parallel to the first axial direction Ax1.

More specifically, the diffuser 190 may gradually become parallel to the first axial direction Ax1, from the inlet of the diffuser 190 toward the outlet thereof. An angle formed between the diffuser 190 and the rotating shaft 140 may decrease as the diffuser 190 moves further away from the rotating shaft 140 in the radial direction.

The direction of flow of the refrigerant discharged by the first impeller 110 is changed to the first axial direction Ax1 between the first axial direction Ax1 and the radial direction.

The diffuser 190 may be defined as the cavity formed in the casings 101, 102, and 103 which accommodate the first impeller 110, the second impeller 120, the motor 180, and the rotating shaft 140. Specifically, the diffuser 190 may be formed at the first shell cover 102. As the diffuser 190 is formed at the first shell cover 102, there is no need for a pipe separately from the casings 101, 102, and 103, such that production costs may be reduced, as well as a required space.

The diffuser 190 may have an annular shape surrounding the rotating shaft 140. When viewed from the axial direction, the diffuser 190 may have a shape surrounding the rotating shaft 140 and the first impeller 110. The center of the diffuser 190 may coincide with the center of the rotating shaft 140.

Further, the diffuser 190 may include a plurality of guide blades 191 arranged along a circumference thereof. The guide blades may be basically formed as a profile blade, a wedge-shaped blade, a circular blade, or an annular blade, for guiding the flow.

In addition, the guide blades may be distributed regularly or irregularly, may be located at the same radial height or at different radial heights, and may have the same shape or different shapes. In each of the cases, there may be one point, having a narrowest cross-section (or throat) between two adjacent guide blades.

By the shape of the diffuser 190, a receiving space 193 may be defined between the diffuser 190 and the rotating shaft 140. As will be described later, the thrust bearing 160 may be disposed in the receiving space 193, such that a volume of the compressor 100 may be reduced.

Moreover, the diffusing passage 153 is connected to the outlet 190b of the diffuser 190 to guide the diffused refrigerant to the second impeller 120. One end of the diffusing passage 153 is connected to the outlet 190b of the diffuser 190, and the other end of the diffusing passage 153 is connected to the second inlet 107.

The diffusing passage 153 may be defined as a cavity formed in the casings 101, 102, and 103 which accommodate the first impeller 110, the second impeller 120, the motor 180, and the rotating shaft 140. As the diffusing passage 153 is formed in the casings 101, 102, and 103, a required space for forming the diffusing passage 153 may be reduced. The diffusing passage 153 may be disposed so as not to overlap with the first impeller 110 and the second impeller 120 in the radial direction. The diffusing passage 153 may extend parallel to the axial direction.

The rotating shaft 140 and the motor 180 for providing a driving force to the first and second impellers 110 and 120 may be provided in the shell 101. Particularly, the motor 180 may be provided as an oilless motor.

The motor 180 includes: a stator 182 having an outer circumferential surface fixed to the shell 101, and an inner circumferential surface forming a rotation space; and a rotor 181 received in the rotation space and rotating relative to the stator 182. The rotating shaft 140, which rotates together with the rotor 181 to transmit a rotational driving force of the rotor 181 to the impellers 110 and 120, is coupled to the rotor 181. The motor 180 is disposed between the first impeller 110 and the second impeller 120.

In this case, the first and second impellers 110 and 120 are respectively coupled to both ends of the rotating shaft 140. The rotating shaft 140 is rotated by the motor 180, and the first and second impellers 110 and 120, coupled to the rotating shaft 140, may be rotated.

The motor 180 may be disposed closer to the rotating shaft 140 than the diffusing passage 153. At least a portion of the motor 180 may overlap the diffusing passage 153 in the radial direction. As the diffusing passage 153 is disposed in an outer area of the motor 180, a connection pipe may be omitted.

The compressor 100 includes the thrust bearing 160 for limiting vibration of the rotating shaft 101 in an axial direction Ax. The thrust bearing 160 supports the rotating shaft in the axial direction.

In order to prevent the vibration of the rotating shaft 140 in the axial direction Ax (left-right direction), the thrust bearing 160 desirably has a predetermined area on a plane perpendicular to the axial direction Ax.

Specifically, the rotating shaft 140 may further include a thrust collar 140a providing a sufficient magnetic force so that the rotating shaft 110 may be moved with the magnetic force of the thrust bearing 160. The thrust collar 140a may have an area wider than a cross-sectional area of the rotating shaft 140 on a plane perpendicular to the axial direction Ax. The thrust collar 140a may extend in a rotation radius direction of the rotating shaft 140.

The thrust bearing 160 is made of a conductive material, around which a coil (not shown) is wound. The coil serves as a magnet, with a current flowing through the wound coil.

The thrust bearing 160 may restrict movement of the rotating shaft 140 in the axial direction Ax and may prevent the rotating shaft 140 from colliding with other components of the compressor 100.

Specifically, the thrust bearing 160 may include a first thrust bearing 160a and a second thrust bearing 160b, which are disposed to surround the thrust collar 140a in the axial direction Ax of the rotating shaft 140. That is, the first thrust bearing 160a, the thrust collar 140a, and the second thrust bearing 160b are disposed in this order in the axial direction Ax of the rotating shaft 140.

More specifically, at least a portion of the rotating shaft 140 is disposed between the first thrust bearing 160a and the second thrust bearing 160b. The thrust collar 141 is desirably disposed between the first thrust bearing 160a and the second thrust bearing 160b.

Accordingly, the first thrust bearing 160a and the second thrust bearing 160b may provide an effect of minimizing vibration of the rotating shaft 140 in a direction of the rotating shaft 140, by the action of the magnetic force and the thrust collar 141 having a wide area. The thrust bearing 160 is provided in a bearing housing 163.

A force of the thrust bearing 160 is inversely proportional to the square of a distance and is proportional to the square of a current. When surge occurs in the rotating shaft 140, a thrust force is generated toward the impeller 120 (toward the right side). In response to the force generated toward the right side, the rotating shaft 140 should be attracted with a maximum force using the magnetic force of the thrust bearing 160, but when the rotating shaft 140 is located in the middle (reference position) between the two thrust bearings 160, it is difficult to force the rotating shaft 140 to be moved rapidly to the reference position in response to a sudden movement of the shaft.

A gap sensor 70 measures movement in the axial direction Ax (left-right direction) of the rotating shaft 140. It is also possible that the gap sensor 70 may measure movement in the vertical direction (direction perpendicular to the axial direction Ax) of the rotating shaft 140. Further, the gap sensor 70 may also include a plurality of gap sensors 70.

For example, in order to measure the horizontal movement of the rotating shaft 140, the gap sensor 70 may be spaced apart in the axial direction Ax from one end in the axial direction Ax of the rotating shaft 140. Specifically, the gap sensor 70 may be spaced apart from the thrust collar 140a in the axial direction Ax, to measure a distance from the thrust collar 140a. The gap sensor 70 may be provided in the bearing housing 163.

The thrust bearing 160 is desirably disposed in a dead zone, at a position not affecting other components. The thrust bearing 160 may be disposed in the receiving space 193 formed by the shape of the diffuser 190 between the diffuser 190 and the rotating shaft 140. The receiving space 193 may have a ring shape which increases toward the first axial direction.

Specifically, at least a portion of the thrust bearing 160 overlaps with the diffuser 190 in the radial direction, and may be disposed closer to the rotating shaft 140 than the diffuser 190. Accordingly, the thrust bearing 160 is disposed in the dead zone formed by the diffuser 190.

The entire thrust bearing 10 may be desirably disposed to overlap the diffuser 190 in the radial direction.

In the present disclosure, a plurality of magnetic bearings 141 may be further included, which support the rotating shaft 140 in the radial direction intersecting the axial direction of the rotating shaft 140.

The magnetic bearings 141 are made of a conductive material, around which a coil (not shown) is wound. The wound coil serves as a magnet, with a current flowing through the wound coil. The plurality of magnetic bearings 141 may be arranged around the rotating shaft 140 to surround the rotating shaft 140.

The magnetic bearings 141 support the rotating shaft 140 in the radial direction intersecting the axial direction of the rotating shaft 140. The magnetic bearings 141 may allow the rotating shaft 140 to rotate without friction while floating in the air. To this end, at least three or more magnetic bearings 141 are required to be arranged around the rotating shaft 140, and the respective magnetic bearings 141 are required to be installed around the rotating shaft 140 while maintaining a balance.

In one embodiment of the present disclosure, four magnetic bearings 141 are symmetrically disposed around the rotating shaft 140, and the rotating shaft 140 may float in the air by magnetic force generated by the coils wound around the respective magnetic bearings 141. As the rotating shaft 140 rotates while floating in the air, energy loss caused by friction may be reduced, compared to a prior art using general bearings.

In addition, the compressor 100 may further include a bearing housing (not shown) supporting the magnetic bearings 141.

The plurality of magnetic bearings 141 may be installed at least at two points of the rotating shaft 101. The two points are different points along a longitudinal direction of the rotating shaft 101. The rotating shaft 101 corresponds to a straight line, such that it is required to support the rotating shaft 101 at least at two points in order to prevent vibration in a circumferential direction. Specifically, the magnetic bearings 141 may include a first magnetic bearing 140a, disposed adjacent to the first impeller 110, and a second magnetic bearing 140b disposed adjacent to the second impeller 120.

At least some of the magnetic bearings 141 may be disposed to overlap the diffuser 190 in the radial direction. By the shape of the diffuser 190, some of the magnetic bearings 141 may be disposed in the receiving space 193 between the diffuser 190 and the rotating shaft 140.

Specifically, at least some of the magnetic bearings 141 may overlap the diffuser 190 in the radial direction, and may be disposed closer to the rotating shaft 140 than the diffuser 190.

The magnetic bearing 141a, disposed adjacent to the thrust bearing 160, may be disposed closer to the motor 180 in the axial direction than the thrust bearing 160.

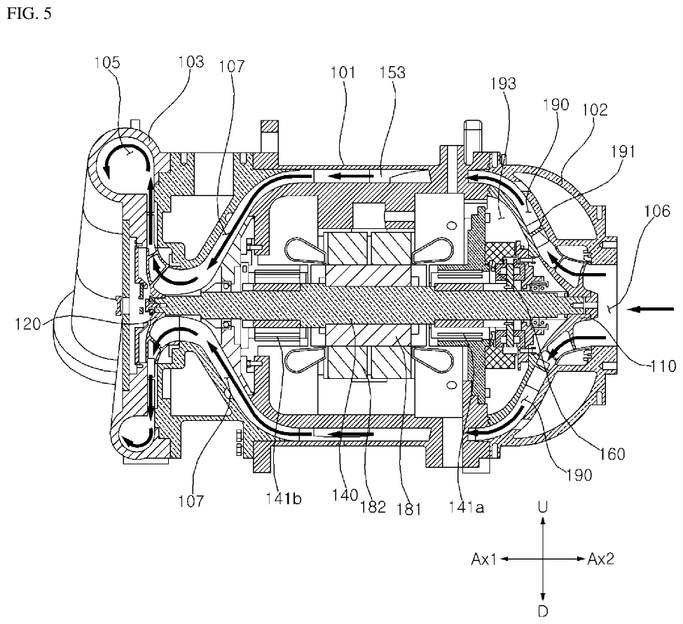

Referring to FIG. 5, as for the flow of the refrigerant, the refrigerant, flowing into the compressor 100 through the connection passage 460 of the compressor 100, flows to the first impeller 110 through the first suction unit 106 to be compressed, and is discharged in a direction between the axial direction and the radial direction.

The compressed refrigerant is diffused by the diffuser 190 and is discharged in a direction parallel to the axial direction. The refrigerant discharged from the diffuser 190 flows to the second inlet 107 through the diffusing passage 153.

The refrigerant flowing to the second inlet 107 may be collected toward the center of the rotating shaft 140 to flow to the second impeller 120. The refrigerant flowing to the second impeller 120 may be compressed to be discharged in the radial direction. The refrigerant discharged from the second impeller 120 may flow to the discharge pipe 105. The refrigerant flowing to the discharge pipe 105 may flow to the condenser connection passage 150.

The compressor and the chiller system of the present disclosure have one or more of the following effects.

First, by providing two impellers, one of which is a mixed flow impeller, and the other is a centrifugal impeller, compression performance may be improved, and the specific speed of the compressor may increase.

Second, by using the mixed flow impeller, the specific speed may increase, such that the mixed flow impeller may be reduced in size, and a size of the compressor may also be reduced.

Third, by efficiently installing the mixed flow impeller, and the diffuser and the thrust bearings disposed at the outlet end of the mixed flow impeller, a dead zone of the compressor may be used, such that the entire size of the compressor may be reduced.

Fourth, in the present disclosure, a direction of the refrigerant flowing to the mixed flow impeller is the same as a direction of the refrigerant flowing to the centrifugal impeller, and the direction is a direction of the center of the compressor, such that the length of the rotating shaft may be reduced, and a space between the rotating shaft and the mixed flow impeller may be used to install other components.

The effects of the present disclosure are not limited to the aforesaid, and other effects not described herein will be clearly understood by those skilled in the art from the following description of the appended claims.

The above described features, configurations, effects, and the like are included in at least one of the embodiments of the present invention, and should not be limited to only one embodiment. In addition, the features, configurations, effects, and the like as illustrated in each embodiment may be implemented with regard to other embodiments as they are combined with one another or modified by those skilled in the art. Thus, content related to these combinations and modifications should be construed as including in the scope and spirit of the invention as disclosed in the accompanying claims.

What is claimed is:

1. A compressor comprising:
a first impeller suctioning a refrigerant in an axial direction and compressing the refrigerant in a direction forming an acute angle with the axial direction;
a second impeller suctioning the refrigerant, compressed by the first impeller, in the axial direction and compressing the refrigerant in a centrifugal direction;
a motor rotating the first impeller and the second impeller; and
a rotating shaft coupled with the first impeller, the second impeller, and the motor,
wherein:
the first impeller is coupled to one end in the axial direction of the rotating shaft, and the second impeller is coupled to the other end in the axial direction of the rotating shaft; and
the first impeller and the second impeller suction the refrigerant in a same direction.

2. The compressor of claim 1, wherein the first impeller comprises a mixed flow impeller, and the second impeller comprises a centrifugal impeller.

3. The compressor of claim 1, wherein the motor is disposed between the first impeller and the second impeller.

4. The compressor of claim 1, further comprising a diffuser diffusing the refrigerant compressed by the first impeller,
wherein:
an inlet of the diffuser is disposed closer to the first impeller in a radial direction of the rotating shaft than an outlet of the diffuser: and
the outlet of the diffuser is disposed closer to the second impeller in the axial direction than the inlet of the diffuser.

5. The compressor of claim 4, wherein:
a direction of the inlet of the diffuser is between a first axial direction, in which the refrigerant is suctioned, and the radial direction of the rotating shaft; and
a direction of the outlet of the diffuser is parallel to the first axial direction.

6. The compressor of claim 4, wherein the diffuser is defined as a cavity formed in casings which accommodate the first impeller, the second impeller, the motor, and the rotating shaft.

7. The compressor of claim 6, wherein the diffuser has an annular shape surrounding the rotating shaft.

8. The compressor of claim 4, further comprising a thrust bearing supporting the rotating shaft in the axial direction,
wherein the thrust bearing is disposed to overlap the diffuser in the radial direction.

9. The compressor of claim 8, wherein the thrust bearing is disposed closer to the rotating shaft than the diffuser.

10. The compressor of claim 4, further comprising a diffusing passage connected to the outlet of the diffuser and guiding the diffused refrigerant to the second impeller,
wherein the diffusing passage is disposed to overlap the motor in the radial direction.

11. The compressor of claim 10, wherein the motor is disposed closer to the rotating shaft than the diffusing passage.

12. The compressor of claim 10, wherein the diffusing passage is defined as a cavity formed in casings which accommodate the first impeller, the second impeller, the motor, and the rotating shaft.

13. The compressor of claim 8, further comprising a plurality of magnetic bearings supporting the rotating shaft in a radial direction intersecting the axial direction of the rotating shaft.

14. The compressor of claim 13, wherein at least some of the magnetic bearings are disposed to overlap the diffuser in the radial direction.

15. The compressor of claim 13, wherein among the magnetic bearings, a magnetic bearing, disposed adjacent to the thrust bearing, is disposed closer to the motor in the axial direction than the thrust bearing.

16. A compressor comprising:
a first impeller suctioning a refrigerant in an axial direction and compressing the refrigerant in a direction forming an acute angle with the axial direction;
a second impeller suctioning the refrigerant, compressed by the first impeller, in the axial direction and compressing the refrigerant in a centrifugal direction;
a motor rotating the first impeller and the second impeller;
a rotating shaft coupled with the first impeller, the second impeller, and the motor;
a thrust bearing supporting the rotating shaft in the axial direction; and
a diffuser diffusing the refrigerant compressed by the first impeller,
wherein the thrust bearing is disposed in a receiving space between the diffuser and the rotating shaft.

17. The compressor of claim 16, wherein:
an inlet of the diffuser is disposed closer to the first impeller in a radial direction of the rotating shaft than an outlet of the diffuser: and
the outlet of the diffuser is disposed closer to the second impeller in the axial direction than the inlet of the diffuser.

18. The compressor of claim 16, wherein:
the first impeller is coupled to one end in the axial direction of the rotating shaft, and the second impeller is coupled to the other end in the axial direction of the rotating shaft; and
the first impeller and the second impeller suction the refrigerant in a same direction.

19. The compressor of claim 16, wherein the first impeller comprises a mixed flow impeller, and the second impeller comprises a centrifugal impeller.

20. The compressor of claim 16, wherein:
a direction of the inlet of the diffuser is between a first axial direction, in which the refrigerant is suctioned, and the radial direction of the rotating shaft; and
a direction of the outlet of the diffuser is parallel to the first axial direction.
